(19) United States
(12) Patent Application Publication
(10) Pub. No.: US 2017/0315713 A1
(43) Pub. Date: Nov. 2, 2017

(54) SOFTWARE APPLICATION CREATION FOR NON-DEVELOPERS

(71) Applicant: Microsoft Technology Licensing, LLC, Redmond, WA (US)

(72) Inventors: Andrew Michael Pennell, Kirkland, WA (US); Irina Koulinitch, Seattle, WA (US); Olivier Colle, Bellevue, WA (US); Mariyan D. Fransazov, Kirkland, WA (US); Muralidhar Sathsahayaraman, Bothell, WA (US); Yudhvir Singh Chauhan, Bellevue, WA (US)

(21) Appl. No.: 15/283,185

(22) Filed: Sep. 30, 2016

Related U.S. Application Data
(60) Provisional application No. 62/329,108, filed on Apr. 28, 2016.

(51) Int. Cl. G06F 3/0484; G06F 9/44; G06F 3/0486; G06F 17/24; G06F 3/01

(52) U.S. Cl. CPC G06F 3/04847; G06F 17/248; G06F 3/017; G06F 3/0486; G06F 8/34

(57) ABSTRACT

Providing a web application that allows users to build applications by interacting with visualizations of code portions. A first application is generated that provides a user interface that includes at least a canvas that comprises a creation area within the user interface in which a user can create a second application. The user interface also includes one or more controls that allow a user to interact with visualizations of code portions using gestures to thereby create the second application on the canvas. The canvas allows a user to create the second application from scratch, such that no template to create the second application is provided. At least one of the one or more controls allows a user to input declarative code in the creation of the second application.

### CROSS-REFERENCE TO RELATED APPLICATION

This application claims the benefit of U.S. Provisional Patent Application Ser. No. 62/329,108, filed Apr. 28, 2016, which provisional patent application is incorporated herein by reference in its entirety.

### BACKGROUND

Computer systems and related technology affect many aspects of society. Indeed, the computer system's ability to process information has transformed modern society. Computer systems now commonly perform a host of tasks (e.g., word processing, scheduling, accounting, and so forth) that prior to the advent of the computer system were performed manually. More recently, computer systems have been coupled to one another and to other electronic devices to form both wired and wireless computer networks. Such networks allow for transferring electronic data to and from computer systems and other electronic devices.

As such, software applications play an integral role in the lives of many individuals. Such software applications consist of computer-executable instructions that have been developed by one or more individuals and/or computer systems. Additionally, oftentimes individuals own multiple computing devices of all shapes and sizes, wherein each computing device may have a different operating system. Accordingly, complex software applications generally need to be able run on multiple different-sized devices and various operating systems, whether or not multiple versions of a particular software application are needed for each different operating system. As such, today's software applications may include hundreds of thousands, or even millions, of lines of code. Years of education and experience may be required in order for an individual to acquire the necessary skill and experience to create such complex cross-platform software applications.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to providing a web application that allows users to build applications by interacting with visualizations of code portions. For example, embodiments may include generating a first application. The first application provides a user interface that includes a canvas that comprises a creation area within the user interface in which a user can create a second application. The user interface also includes control(s) that allow a user to interact with visualizations of code portions using gestures to thereby create the second application on the canvas.

As such, a cross-platform software application may be created by author(s) via a cross-platform foundational web application that allows for creating essentially unlimited types of applications. Such functionality may be provided via the foundational application by including the canvas that can be manipulated using various options/tools provided by the web/cloud-based platform. Such a canvas may allow an author to create an application from scratch (i.e., without providing a template for creating applications). Furthermore, an author may input various rules/expressions to bind nodes of a created application to thereby create additional functionality within the created application.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer system in which the principles described herein may operate.

FIG. 2 illustrates an example user interface of a foundational application that allows a user to create complex cross-platform applications using simple gestures.

FIGS. 3A and 3B illustrate additional example user interfaces of a foundational application that allows a user to create complex cross-platform applications using simple gestures.

FIG. 4 illustrates a flow chart of an example method for providing a web application that allows users to build applications by interacting with visualizations of code portions.

FIG. 5 illustrates a portion of an example user interface of a foundational application being used at a mobile device.

FIG. 6 illustrates an example user interface of a foundational application for selecting a template from which to begin creating an application.

FIG. 7 illustrates a method for handling assets during the creation of an application.

### DETAILED DESCRIPTION

At least some embodiments described herein relate to providing a web application that allows users to build applications by interacting with visualizations of code portions. For example, embodiments may include generating a first application. The first application provides a user interface that includes at least a canvas that comprises a creation area within the user interface in which a user can create a second application. The user interface also includes one or more controls that allow a user to interact with visualizations of code portions using gestures to thereby create the second application on the canvas.

As such, a cross-platform software application may be created by one or more authors via a cross-platform foundational web application that allows for Turing complete application creation (i.e., essentially unlimited types of applications can be created). Such functionality may be provided via the foundational application by including the canvas that can be manipulated using various options/tools provided by the web/cloud-based platform. Such a canvas may allow an author to create an application from scratch, wherein no template for creating applications is provided. Furthermore, an author may input various rules/expressions to bind nodes of a created application to thereby create additional functionality within the created application.

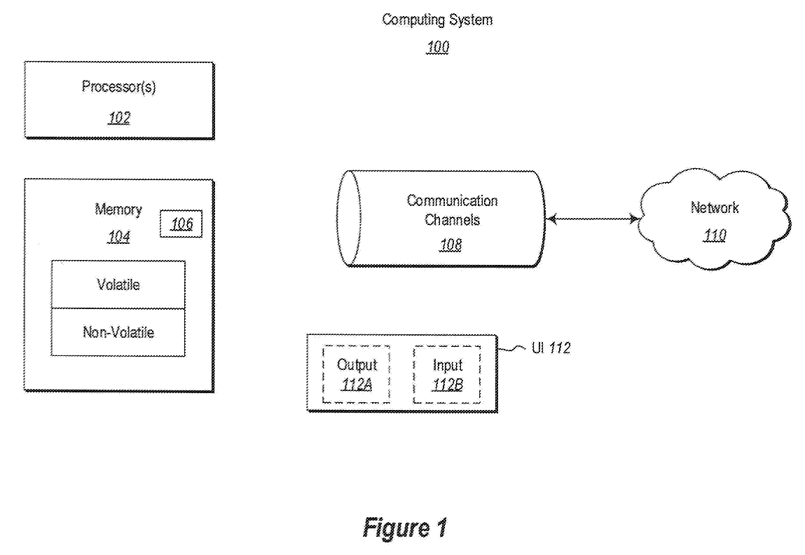

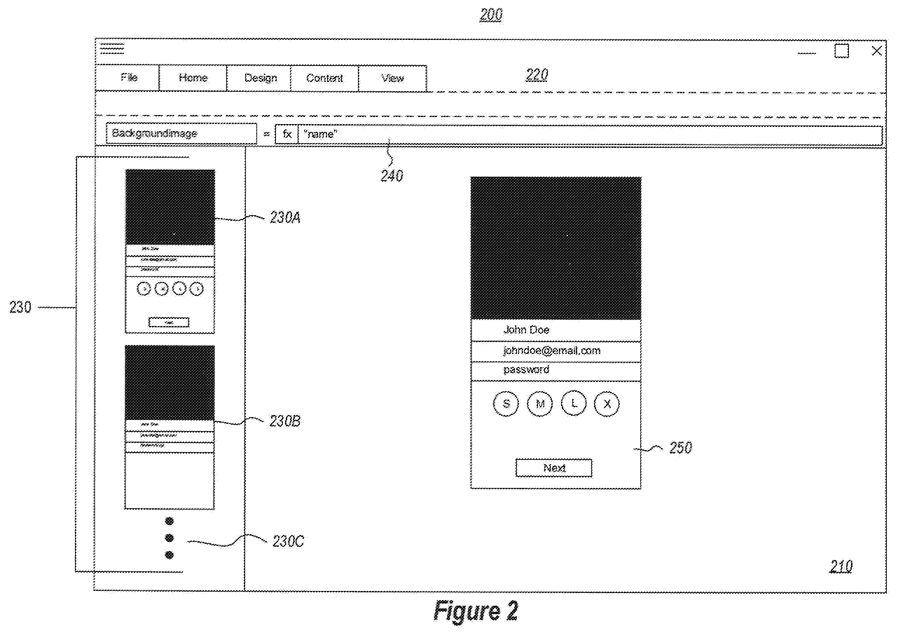

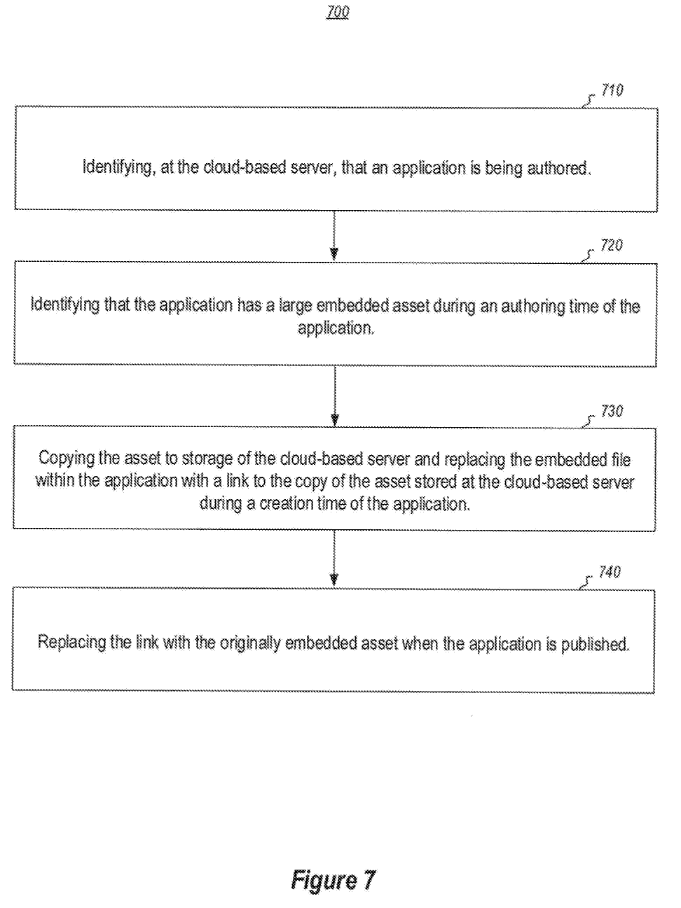

Some introductory discussion of a computing system will be described with respect to FIG. 1. Then, providing a web application that allows users to build applications by interacting with visualizations of code portions will be described with respect to FIGS. 2 through 6. Additionally, how to handle assets used in an application during creation of the application will be described with respect to FIG. 7.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module”, “control”, or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

FIG. 2 illustrates a foundational web/cloud-based application (hereinafter referred to as the “foundational application”), wherein the foundational application provides a user interface 200. The user interface 200 may allow a user to interact with visualizations of underlying code portions (i.e., the code underlying the visualizations is not visible to a user) via gestures to thereby create a software application (hereinafter referred to as the “created application”) on a canvas 210 of the user interface. In some embodiments, a created application may be created specifically for mobile devices (e.g., phones, tablets, smart watches, and so forth) which may access the created application from the cloud. In other embodiments, a created application may be a desktop application. In yet other embodiments, a created application may function in both a mobile and desktop computing environment.

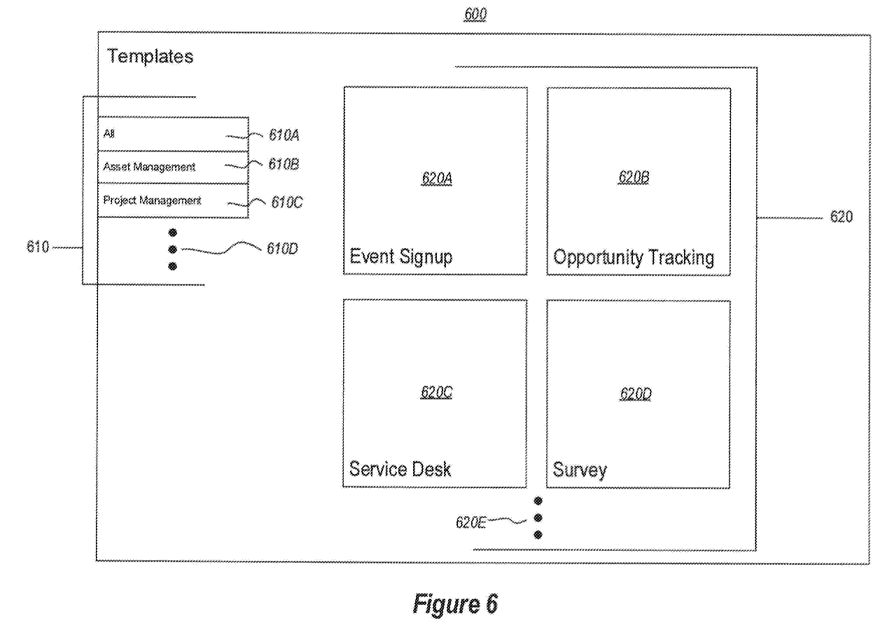

Such a web application may allow users/authors (i.e., those users that are authoring/creating a created application using the foundational application) who are not software developers, or authors that have only a minimal amount of software development experience, to author created applications. For instance, the canvas 210 can be manipulated/modified using simple gestures to author a created application 250, as described more fully herein. Additionally, the canvas 210 may allow a user to author an application from scratch such that no template is used during the creation of an application. Allowing a user to author a created application from scratch in this way provides essentially unlimited types of applications that can be created. In other embodiments, various templates may be available to assist users in authoring new applications, as described more fully with respect to FIG. 6. Notably, when using a template to create an application, the template may be manipulated in any number of ways such that Turing complete application creation is still possible. In other words, a template may simply be used as a starting point that can be manipulated in arbitrary (and essentially unlimited) ways during creation of an application.

While FIG. 2 illustrates the created application 250 within the canvas in a portrait view, the created application 250 may be manipulated to illustrate a landscape view, as well. FIG. 2 also includes a ribbon 220 that runs across the top of the user interface 200 and allows an author to choose from many different options/tools with which to modify the canvas 210, and ultimately the created application 250. The ribbon may include options/tools and/or a User Interface (UI) that has a familiar look and feel. For instance, the ribbon may have options/tools that are similar to, and/or a look and feel similar to, well-known and widely-used word processor applications, presentation applications, and/or spreadsheet applications (e.g., MICROSOFT® WORD, GOOGLE DOCS™, APPLE® PAGES®, MICROSOFT POWERPOINT®, GOOGLE SLIDES, APPLE KEYNOTE®, MICROSOFT EXCEL®, GOOGLE SHEETS™, APPLE NUMBERS®, and so forth). Accordingly, the foundational application may be user-friendly and intuitive.

The various options/tools provided by the ribbon 220 may include, but is not limited to, the ability to insert buttons, insert text boxes, insert animations, insert data, insert visuals (e.g., pictures, videos), insert drop-down menus, and select sensors (e.g., camera, accelerometer, gyroscope, gps, and so forth) from which to receive input and/or at which to receive input. Additionally, the options/tools provided by ribbon 220 may include the ability to connect to outside sources of data (e.g., data stored within a cloud storage account, databases, websites, or any other real world data, and so forth), automate connections to outside data sources, modify outside data sources, and modify data within the software application.

The options/tools may further include the ability to select defined transformations (e.g., of data, of windows, of sensor data, of visualizations, and so forth), demonstrate output (e.g., from sensors, data sources), and so forth. Similarly, an author may interact with the ribbon 220, the ribbon's options, tools, sensors, visualizations, and so forth using any number of gestures (drag-and-drop, multi-touch gestures, single tap, double tap, copy-and-paste, cut-and-paste, and so forth). For instance, an author may use a drag-and-drop gesture to add a control (e.g., a button, a slider, a text box, and so forth) to the created application 250. While all of these options/tools are discussed as being included within the ribbon, they may also be included in a sidebar, drop-down menu, and so forth.

FIG. 2 also includes two separate windows 230 (i.e., 230A and 230B), each window comprising a different window (or page) of created application 250. Again, this functionality may be similar to a presentation/slideshow application that has multiple windows that each have an associated canvas 210 that can be modified. While FIG. 2 shows only two windows 230, ellipses 230C represents that there may be any number of windows of a created application 250 having an associated canvas 210, including as few as one window 230. The use of multiple windows 230 may allow a user to author a created application 250 that allows for navigation to and from multiple windows 230. Additionally, multiple windows 230 may provide various, different functionality within each window 230 of a created application 250.

As a specific example, the created application 250 of FIG. 2 shows at least five buttons that have been added to the created application 250/canvas 210, including buttons ‘S,’ ‘M,’ ‘L,’ ‘X,’ and ‘Next.’ For instance, any one of the ‘S,’ ‘M,’ ‘L’ and ‘X’ buttons may be selected as a t-shirt size. Likewise, the ‘Next” button may be selected as a navigational tool, for example, to navigate from window 230A to window 230B. Accordingly, a created application 250 may have multiple windows 230, each window 230 having an associated canvas 210 that may have multiple visuals, each visual having design data and behavioral properties that may allow an author to connect the windows and/or visuals together in any number of ways.

While the foundational application may allow a user to author a created application without requiring the user to input any expressions/code, the user interface of the foundational application may also include a function editor 240, as illustrated in FIG. 2. Accordingly, while an author may be able to modify a created application to provide many different tools, services, functionalities, and so forth, by simply interacting with the various options/tools included in the ribbon, the author may also be able to add functionality to a created application by using the function editor to write declarative expressions/code (i.e., declarative expressions similar to expressions used in MICROSOFT EXCEL), as described more fully herein.

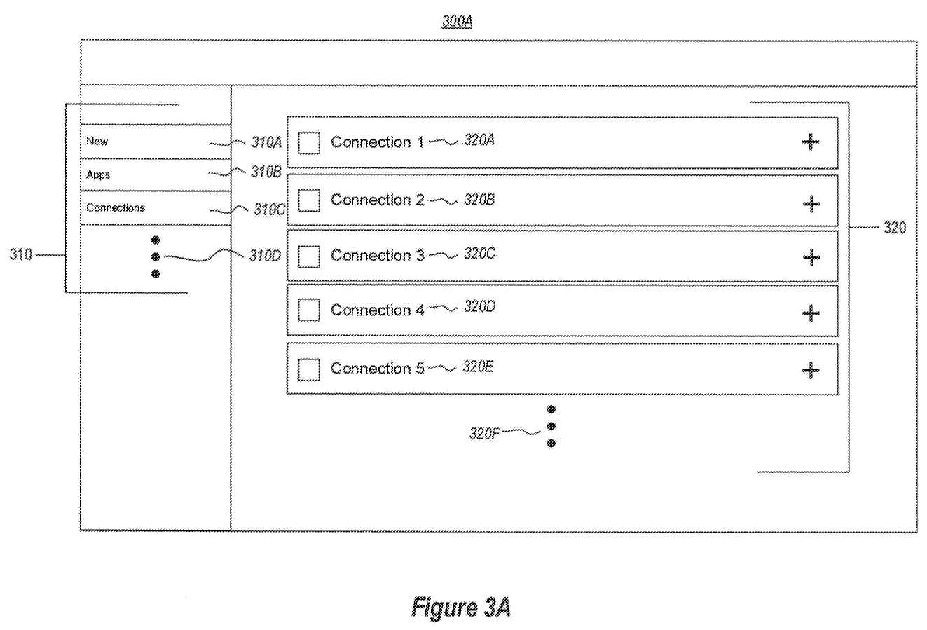

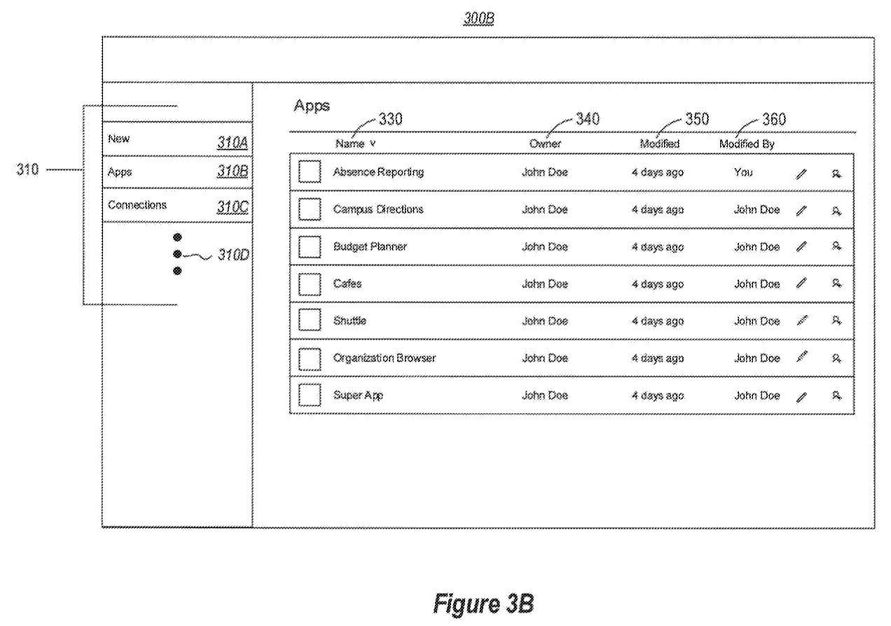

FIG. 3A illustrates a user interface 300A of the foundational application that includes various controls (310A through 310D) within a sidebar control 310. As shown, sidebar control 310 includes new control 310A that allows a user to create a new application, apps control 310B that allows a user to see all created apps (as discussed in further detail with respect to FIG. 3B), and connections control 310C (as discussed in further detail with respect to FIG. 3A). Additionally, FIG. 3A includes ellipses 310D, which shows that any number of controls may be included within sidebar control 310. As briefly described, user interface 300A of the foundational application illustrates an example user interface when a user/author has selected connections control 310D within sidebar control 310. As illustrated in FIG. 3, and briefly mentioned herein, various connections 320 (320A through 320F) of a created application or a created application's nodes (data, sensors, visualizations, text boxes, buttons, and so forth) to data sources, sensors, and so forth may be created through a user interface 300 of the foundational application. In other words, a user may be able to connect a created application to one or more external services/connections 320.

For instance, FIG. 3 demonstrates five possible connections 320 (320A through 320F) that a user can connect to a created application. For instance, connections 320 may comprise social media websites/applications (e.g., TWITTER®, FACEBOOK®, and so forth), cloud storage services (e.g., GOOGLE DRIVE™, DROPBOX®, and so forth), databases (e.g., SQL), subscription services (e.g., SALESFORCE®), and so forth. While these are some specific examples of possible connections, connections may be made with any data source, third party application, website, third-party web application, and so forth via the user interface 300. Similarly, while only five possible connections 320 are shown, ellipses 320F represents that there may be any number of possible connections 320 corresponding to a created application and/or the user interface 300A of the foundational application.

The ease of authoring of an application may be enabled through the use of applications that take the form of transformation chains. A transformation chain is an interconnected set of nodes that each may represent data sources or data targets. There are links between the nodes, each link representing a transformation. For instance, the transformation may be declaratively defined within the function editor portion of the user interface of FIG. 2. For any given link, the associated transformation receives copies of values of one or more data sources (e.g., connections 320) situated at an input end to the link, and generates resulting values being provided at one or more data targets located at the output end of the link. For any given transformation, when a value at one or more of the data sources at its input end changes, the transformation is automatically reevaluated, potentially resulting in changes in value(s) of one or more data targets at the output end of the transformation. An input node of a transformation chain may be, for instance, a sensor, a data source, or a UI control that receives input. An output node of a transformation chain may be, for instance, a data target, a visualization, or a UI control that outputs data.

In one embodiment, regardless of how complex the transformation chain is, the transformations may be constructed from declarative statements expressing equations, rules, constraints, simulations, or any other transformation type that may receive one or more values as input and provide resulting one or more values as output. Transformation chains may be augmented as a program is built by linking different transformation chains to honor the dependencies between the chains. Such dependencies may be declaratively defined using the function editor portion of FIG. 1. Accordingly, as the author builds the application incrementally, the transformation chain that represents the application likewise augments incrementally.

As briefly mentioned, the function editor may accept easy-to-use programming languages and expressions (e.g., declarative language) as input. For instance, the function editor may accept declarative expressions (similar to the expressions used in MICROSOFT EXCEL) as input. Using EXCEL-like declarative expressions as the programming language for the function editor may be advantageous because it is widely used, even by many individuals who are not developers (or have no other software development experience). Furthermore, it is easy to determine desired EXCEL-like expressions on the internet by performing simple internet searches. Accordingly, an author may be able to input functions, expressions, rules, and so forth to thereby manipulate nodes (e.g., data, sensors, windows, visualizations, and so forth) within a created application.

Additionally, the canvas 210 and/or a user interface of a created application 250 may be presented to an author throughout the entire process of building a created application in exactly the way it would appear, if published at that given moment. In other words, the presentation by the foundational application during the building of a created application includes ‘what you see is what you get’ (WYSIWYG) functionality at each stage of the authoring process. Such functionality not only allows an author to see visuals of exactly what a created application will look like, but also how the created application functions at each stage. Accordingly, an author may test the functionality of a created application within the foundational application throughout the created application authoring process, building with confidence on their prior construction, knowing they are building on a proper foundation. Furthermore, an author (or authors) may be able to build a created application a little bit at a time and/or modify an already published created application after it has been initially published.

As illustrated in FIG. 3B, multiple various authors may contribute to a single created application. FIG. 3B illustrates a user interface 300B of the foundational application when a user has selected the apps control 310B within the sidebar control 310. As shown, all of an author's created applications can be saved and presented in a single interface. Furthermore, FIG. 3 illustrates an example user interface 300B for accessing all of an author's created applications, whether the author actually authored the created application or has simply been given access to it. User interface 300B includes application name column 330 that shows the name of each created application, application owner 340 that shows the owner of each created application, modification date column 350 that shows the last date on which each created application was modified, and modification identifier column 360 that identifies who last modified each created application.

In an example, during the created application authoring process, a first author may desire to have another author(s) contribute to the building of the created application. As such, the foundational application may provide an author the ability to invite others to contribute to the building of a created application. Similarly, an author may be able to invite others to simply use a created application, including assigning permissions to those who have received invitations. For instance, an author may give read privileges to an individual with respect to a created application, but not write privileges. Accordingly, an author may be able to invite others to view, use, and/or contribute to a created application by assigning specific permissions/privileges to each invited user. Portions of transformation chains may also be delegated to other devices and/or users.

Furthermore, such functionality may be provided across platforms. Accordingly, authors with different web browsers (e.g., MICROSOFT INTERNET EXPLORER®, MICROSOFT EDGE, GOOGLE CHROME™, APPLE SAFARI®, and so forth) and/or different operating systems (e.g., MICROSOFT WINDOWS®, GOOGLE CHROME OS™, GOOGLE ANDROID™, APPLE OS X®, APPLE IOS®, and so forth) may all contribute to the building of a created application. For example, a first contributor may begin the authoring of a created application using MICROSOFT EDGE on a computer running MICROSOFT WINDOWS, while a second contributor is using APPLE SAFARI on a computer running APPLE OSX and a third contributor is using GOOGLE CHROME on a computer running MICROSOFT WINDOWS.

Once a created application has been finished, it may be published and saved on the cloud. Accordingly, it can then be used by others who have been given access by the creator(s), regardless of the platform (i.e., cross-platform functionality). For example, once saved/published, a created application may be consumed by a first end user running MICROSOFT WINDOWS on a smart phone, a second end user running ANDROID on a tablet, and a third end user running APPLE IOS on a smart phone. Thus, the foundational application may provide cross-platform functionality for both creation and consumption of a created application.

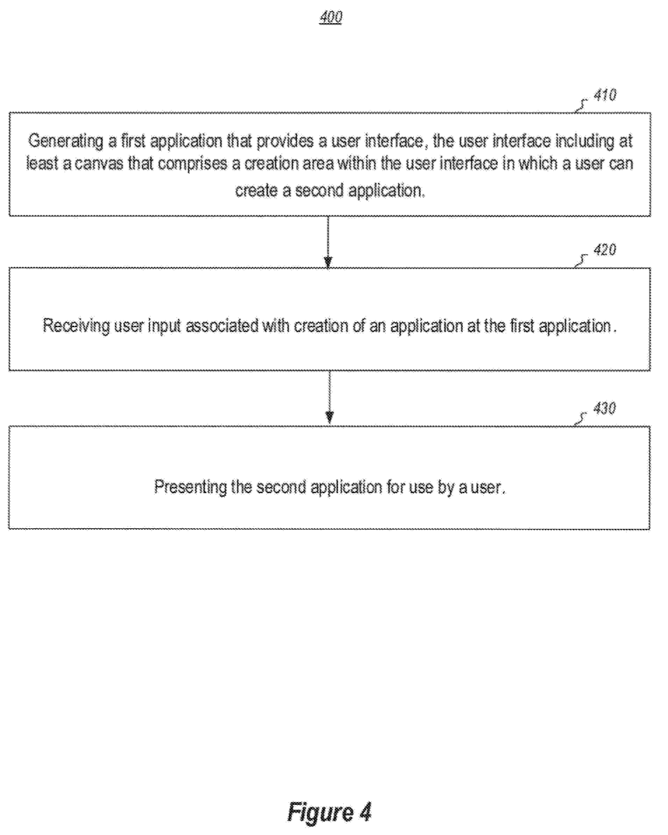

FIG. 4 illustrates a method for providing a web application that allows users to build applications by interacting with visualizations of code portions. FIG. 4 is described with frequent reference to the user interface 200 of the foundational application, as illustrated in FIG. 2. The method 400 includes generating a first application that provides a user interface 200 (Act 410). The user interface 200 includes at least a canvas 210 that comprises a creation area within the user interface 200 in which a user can create a second application 250. As described herein, the canvas may allow a user to create the second application 250 from scratch, such that no template to create the second application 250 is provided.

The user interface 200 may also include one or more controls (i.e., included within ribbon 220) that allow a user to interact with visualizations of code portions using one or more gestures to thereby create the second application on the canvas. For instance, an author with little, or no developing experience, may create an application using simple gestures such as drag-and-drop, cut-and-paste, and so forth. Once the user first application is generated, user input associated with creation of an application may be received at the first application (Act 420). For example, input may be received that creates various user interface controls to be displayed at a user interface of the second application. The method may further include presenting the second application for use/consumption by a user (Act 430). For instance, once the second application has been generated, a user interface of the second application may be published and presented to an end user such that the user can utilize the second application in the manner for which it was created.

Notably, the authoring experience hides the concept of source code in a declarative model called herein a document. The document consists of, among other things, an entity store and rules (i.e., expressions, formulae, and so forth) that bind them together. A compiler component is used to translate the non-executable declarative document to a fully functional cross-platform application. The invention decouples the user experience of authoring an application from scratch and the document compiler component. By hosting the document code as a cloud service and introducing an API layer to consume it, the concepts described herein allow a web-based client to create mobile apps from any platform, and allow mobile apps to consume the application on any platform. Furthermore, during the authoring phase, the output of the compiler component residing on the service side may be transmitted as incremental or complete code snippets to the foundational web application where the snippets are executed.

In this way, a cross-platform software application may be created by one or more authors via a cross-platform foundational web application that allows for Turing complete application creation (i.e., essentially unlimited types of applications can be created). Such functionality may be provided via the foundational application by including a canvas that can be manipulated using various options/tools provided by the web/cloud-based platform. Such a canvas allows an author to create an application from scratch, wherein no template for creating applications is provided. Furthermore, an author may input various rules/expressions to bind nodes of a created application to thereby create additional functionality within the created application.

While the foundational application that allows an author to build a created application from scratch may generally apply to a web application as described herein, a foundational application may also be generated for any given mobile device (e.g., smart phone, tablet, smart watch, and so forth) or mobile operating system. Accordingly, a foundational mobile application may be created for any mobile operating system (e.g., MICROSOFT WINDOWS, GOOGLE ANDROID, APPLE IOS, and so forth) that allows an author to either edit an already created application or to build an application from scratch.

However, because of the limited screen sizes of mobile devices, such a foundational mobile application may offer much less space for the ribbons and sidebars (and the controls included therein) as discussed herein with respect to the foundational web application. As such, the same controls (e.g., function editor 240, connections control 310C, and so forth) discussed with respect to the foundational web application may be ordinarily hidden from an author's view, but may be accessed by any number of touchscreen-based gestures (e.g., swiping from the far left of a screen, swiping from the far right of a screen, press-and-hold, double tap, a selectable ellipses element, other selectable elements that expand to show more controls/capabilities, and so forth).

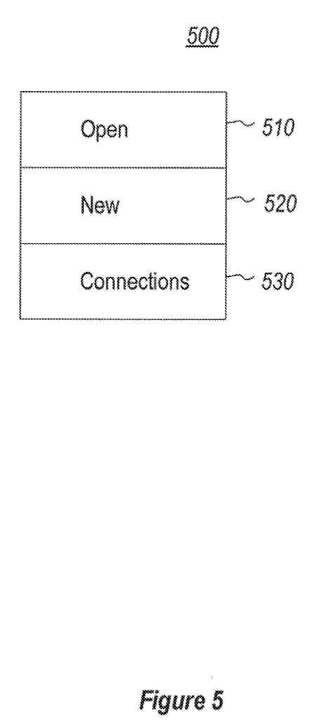

For example, the sidebar control 500 shown in FIG. 5 may be initially/ordinarily hidden until an author performs one of the touchscreen-based gestures described (e.g., swiping from the edge of a screen, interacting with ellipses, and so forth). As illustrated in FIG. 5, sidebar control 500 includes an open control 510 that may allow a user to view any created (or currently being created) applications to which the user has access, new control 520 that may allow a user to create a new application, and connections control 530 that may allow a user to view potential, or current, connections to external services. Such a sidebar control 500 may be similar to the sidebar control 310 of FIG. 3A.

When first starting to create an application, the foundational mobile application may present an author with the choice of starting an application from scratch, continuing the creation of an application that has already been started, or starting from a template. FIG. 6 illustrates an example user interface 600 when a user decides to start creating an application from a template. As shown in FIG. 6, when an author selects to start from a template, the author may be presented with various templates 620 from which to choose.

As illustrated, FIG. 6 shows four examples of possible templates (620A through 620D) from which to choose, such as an event signup template 620A, an opportunity tracking template 620B, a management service desk template 620C, and a survey template 620D, a calendar template. While only four templates are displayed, ellipses 620E represents that there may be any number of possible templates from which a user may begin creating an application (e.g., financial budgeting template, personal financial/investment template, mortgage calculator, and so forth).

Furthermore, as illustrated in FIG. 6, an author may be presented with template genre control 610 that allows a user to view templates that are organized based on genre. As shown, template genre control 610 includes an all templates control 610A that allows a user to view all of the available templates regardless of any genre designation, an asset management template control 610B that allows a user to view all templates relating to asset management, and project management template control 610C that allows a user to view all templates relating to project management. While only two genre controls (610B and 610C) are shown, ellipses 610D represents that there may be any number of different genres of templates having associated controls included in template genre control 610.

Once an author has selected a template, the author may simply publish the template as an application or only make minimal changes before publishing a created application from the template. However, an author may also use the template as only a starting point for a created application. Accordingly, an author who has chosen a template may then edit the template in any number of ways via various touchscreen-based gestures (e.g., swiping from the far left of a screen, swiping from the far right of a screen, press-and-hold, double tap, a selectable ellipses element, other selectable elements that expand to show more controls/capabilities, and so forth) or using a function editor similar to function editor 240 to input declarative expressions, as described herein. Accordingly, a user may still be able to create a Turing complete application while using a template as a starting point. For example, an author may be able to use touchscreen-based gestures to select controls/options of the foundational mobile application with which to edit an application, as well as to edit a selected template in any number of ways.

More specifically, after selecting a template an author may choose to edit/modify the created application/template by adding more visual controls, deleting visual controls, modifying visual controls, adding data sources, deleting data sources, modifying data sources, modifying inputs/outputs, inserting/deleting multimedia (e.g., images, videos, and so forth), and take any other applicable actions by either using touchscreen-based gestures to interact with controls/options of the foundational mobile application or by using touchscreen-based gestures to interact directly with the controls/visualizations of the template/created application itself. In a more specific example, a user may decide to change a data source that is outputting photos/videos on a created application that started from a template from the camera of a mobile device to a folder on a social media application.

In this way, an author may use the foundational mobile application on a mobile device having a limited screen size to create diverse and complex applications. Creating apps via the foundational mobile application may further be accomplished by accessing controls/options of the foundational mobile application through touchscreen-based gestures, despite the limited screen size. Additionally, an author may be able to select from various templates that may then be edited in any number of ways using touchscreen-based gestures to interact with both visuals/controls of the selected template, as well as controls/options of the foundational mobile application.

When creating an application using the foundational application (whether web, desktop, mobile, and so forth), the created application itself may be stored (as well as at least partially executed) in the cloud, during the creation of the application, as well as after the application has been published. As such, a cloud-based server that performs at least part of the execution with respect to creating an application may intelligently store/manage any assets (i.e., video, images, music, or any other files) that are used within the application during the app's creation, as well as after the application has been published.

For example, a user may include a video within an application that has a file size of one gigabyte. Such a video may be included in the application both during the creation process and after the application has been published/shared with others. Suppose the video is currently saved to a third party source or even on a device being used by the author to create the application (i.e., the asset is anywhere other than the cloud where the application is being stored and at least partially executed).

When using the video within the application, the author may either choose to embed the video within the application or insert a link to the video within the application. If the user decides to embed the video within the application, the video may have to be transmitted from where the video is stored (e.g., author's device, third party cloud storage, and so forth) to the cloud-based server responsible for saving/executing the application, each time the video is manipulated in any way. For example, if the author performs a cut-and-paste/copy-and-paste of the video, moves the video from one window 230 to another window 230, or performs various other manipulations of the video, the entire one gigabyte video may have to be transmitted from the storage location to the cloud-based server of the application each time such a manipulation occurs.

Because authoring is dynamic (i.e., the application is likely to be continually changed/manipulated during the creation process), such an embedded video may be transmitted from the video's storage location to the cloud-based server of the application thousands of times during the application creation process. With large embedded files, the application creation process can thus be very wasteful in terms of both bandwidth usage and data usage with respect to metered connections (e.g., mobile phone data plans). Linking an asset, on the other hand, may entirely avoid this problem, as a link may be easily provided to the storage location of the asset.

As such, a method 700 for intelligently using the benefits of linking to manage application assets and avoid the wasted bandwidth/data associated with embedded assets is illustrated in FIG. 7. The method includes identifying, at the cloud-based server, that an application is being authored (Act 710). Once it has been identified that an application is being authored, some logic and heuristics may be applied to the application to determine if certain conditions have been met. For example, the logic/heuristics may be focused towards identifying applications that have an asset embedded, wherein the file size of the asset is large (Act 720). Additionally, this identification of a large embedded file may be performed during a creation time of the application (i.e., while the application is being created by the author). Whether a file size is large may be author-defined, may be server-defined, may be modified at any time, may be dynamic based on circumstances, and so forth. In some embodiments, a file size may be determined as large if it is a video of 20 megabytes or more, an image of 2 megabytes or more, a music file of more than 10 megabytes, and so forth. In other embodiments, a file may be determined as large if it is a video of more than 10 megabytes, an image of more than 0.5 megabytes, a music file of more than 5 megabytes, and so forth.

Once the applied logic/heuristics have been met (i.e., in the present example, an asset is both embedded and large), the cloud-based server may automatically upload a copy of the asset to storage of the cloud-based server (e.g., may be storage of the server itself, may be cloud storage to which the server has access, and so forth) and then replace the embedded file within the application with a link (e.g., a URL link) to the copy of the asset stored at the cloud-based server (Act 730). In some embodiments, the cloud-based server may perform these actions only with respect to the time period of authoring/creating the application. Accordingly, as soon as the application has published, the cloud-based server may automatically replace the link with the applicable embedded asset, as the critical time period (i.e., the time period during which there is a danger of the asset being transmitted hundreds or thousands of times) is generally only during creation of the application (Act 740).

Additionally, the cloud-based server may perform these actions such that the client (i.e., the local device, local application) forgets that the asset was supposed to be embedded and therefore, willingly uses the link to the asset. Likewise, at publishing time, the client may forget that the embedded asset became a link to the asset, and thus willingly use the embedded asset once again. As such, the cloud-based server of the application may perform these actions by itself, without any client knowledge or awareness of the actions being performed.

While the logic/heuristics of the cloud-based server discussed above relate to whether an asset is both embedded and large, any number of conditions may be analyzed by the cloud-based server in order to determine whether an asset embedded within an application should be copied to storage of the cloud-based server and replaced with a link to the copy of the asset, during a creation time of the application. For example, considerations may include a storage location of the asset (i.e., is the connection to a storage location particularly slow), network speeds (e.g., dial-up connection, fiber optic connection, and so forth), sensitivity/security of the asset, and so forth.

In a more specific example, the logic/heuristics may consider whether a file is embedded, whether a file is large, the speed of a data connection, and whether any data metering/data caps apply to a client/author. In such a case, if the logic/heuristics determine that there is a large embedded file, but that the client/author has access to gigabyte per second network speeds and no metered connection/data cap, then the cloud-based server may decide to leave the embedded asset as is. However, in other embodiments, the logic/heuristics of the cloud-based server may determine that despite the fast network speeds and lack of a metered connection/data cap, the embedded asset is still to be copied to storage of the cloud-based server and replaced with a link to the asset copy during application creation time.

In this way, when an author is creating an application (via the foundational application) having a large embedded asset, logic/heuristics of the cloud-based server may be able to identify such (i.e., that the asset is both embedded and large), and save large amounts of bandwidth and data. Such gains may be provided by the cloud-based server copying the embedded asset to storage of the cloud-based server, replacing the embedded asset with a link to the copy of the asset stored at the cloud-based server during a creation time of the application, and then replacing the link to the asset copy with the embedded asset during a publish time of the application.

The foundational application and/or created applications, as described above, may also be capable of supporting sequential execution of batch commands that may be created and at least partially performed outside of an environment of the foundational application. For example, selecting a link (e.g., a URL, a URI, and so forth) outside of the foundational application that includes a number of batch parameters and is directed to the foundational application (or a created application) may open the foundational application (or the created application) and cause the foundational application (or the created application) to perform the included batch commands/parameters in sequence.

Accordingly, appropriate semantics may be included with respect to both the web browser and the foundational application (or a created application) to cause the batch parameters to be seen as commands that are to be performed in sequence (instead of being performed in parallel or possibly ignored). For example, suppose an individual has received an email with the following URL link: https://fake-foundational-application.com/? createAFD&DS=footballteam-[batchparameter] [batchparameter]. When the individual selects the URL link, a web browser may first launch, then the web browser may identify the additional parameters included in the URL (i.e., a command to create application from data, data source being defined as “footballteam”, and so forth). Before executing the identified batch parameters, a verification may occur (by some combination of the web browser, operating system, and foundational application) to ensure that all of the batch parameters/commands are legitimate and/or allowed. Once verified, the foundational application may first be opened, followed by the foundational application performing the batch parameters/commands included in the URL in sequence.

Accordingly, the batch commands included in the present example may cause the foundational application to create an application from data that is identified as being “footballteam.” At that point, the foundational application may use logic/heuristics and the shape/type of data received and intelligently create an application with the data slider visuals for data that includes numbers, labels for data that includes text, and so forth. Subsequently, the foundational application/the newly created application may perform each of the next two batch parameters in succession.

While the example above comprises opening the foundational application/created application in a browser, selection of the URL may also open a desktop or mobile version of the foundational application/created application. Similarly, while the batch commands included in the previous example comprise creating an application from data and identifying the data source, the operations included within a set of batch commands may be nearly limitless.

For example, operations may include opening a brand new application creation/authoring page, connecting an application to particular data, updating the foundational application, presenting the foundational application (or a created application), performing actions in the cloud with respect to a generated application (i.e., no UI is presented to the user), and so forth. Furthermore, batch executions with respect to the foundational application (or created applications) may also support deep linking. For example, deep linking in the context of the foundational application (or a created application) may include navigating to a particular screen within a created application, navigating to a screen that allows the most customization, highlighting a particular element (i.e., the element with the highest value) within a specified screen, customizing a particular screen or element within a particular screen, and so forth.

Batch execution with respect to the foundational application (or a created application) may also include inherent security, which inherent security comes from the declarative transformation chain/graph model on which the foundational application/created applications are based (i.e., the declarative transformation chain/graph as described herein). The declarative transformation chain may have complete control over what is executed with respect to the foundational application/created applications. Accordingly, any particular operation/command to be executed with respect to the foundational application/created applications may be validated by the underlying security before any execution occurs.

In this way, the foundational application and/or created applications may be capable of supporting sequential execution of batch commands that can be created, and at least partially performed, outside of an environment of the foundational application/created application. Furthermore, any operations performed may be completely secure based on the underlying declarative transform chain of the foundational application/created applications.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A computer system, comprising:
one or more processors; and
one or more computer readable storage media having stored thereon computer-executable instructions that are executable by the one or more processors to cause the computer system to provide a web application that allows users to build applications by interacting with visualizations of code portions, the computer-executable instructions including instructions that are executable to cause the computer system to perform at least the following:
generate a first application, the first application providing a user interface, the user interface including at least:
a canvas comprising a creation area within the user interface in which a user can create a second application; and
one or more controls that allow a user to interact with visualizations of code portions using one or more gestures to thereby create the second application on the canvas.

2. The computer system in accordance with claim 2, wherein the canvas allows a user to create the second application from scratch, such that no template to create the second application is provided.

3. The computer system in accordance with claim 2, wherein the user interface also includes one or more templates.

4. The computer system in accordance with claim 2, wherein at least one of the one or more controls allows a user to input declarative code.

5. The computer system in accordance with claim 2, wherein at least one of the one or more controls allows a user to add one or more controls to the second application.

6. The computer system in accordance with claim 2, wherein at least one of the one or more controls allows a user to connect to one or more external services.

7. The computer system in accordance with claim 6, wherein at least one of the one or more external services comprises a database.

8. The computer system in accordance with claim 2, wherein at least one of the one or more gestures includes dragging-and-dropping at least one user interface control to be presented in a user interface of the second application.

9. A method, implemented at a computer system that includes one or more processors, for providing a web application that allows users to build applications by interacting with visualizations of code portions, comprising:
generating a first application, the first application providing a user interface, the user interface including at least:
a canvas comprising a creation area within the user interface in which a user can create a second application; and
one or more controls that allow a user to interact with visualizations of code portions using one or more gestures to thereby create the second application on the canvas.

10. The method in accordance with claim 9, wherein the canvas allows a user to create the second application from scratch, such that no template to create the second application is provided.

11. The method in accordance with claim 9, wherein the user interface also includes one or more templates.

12. The method in accordance with claim 9, wherein at least one of the one or more controls allows a user to input declarative code.

13. The method in accordance with claim 9, wherein at least one of the one or more controls allows a user to add one or more controls to the second application.

14. The method in accordance with claim 9, wherein at least one of the one or more controls allows a user to connect to one or more external services.

15. The method in accordance with claim 14, wherein at least one of the one or more external services comprises a social media application.

16. The method in accordance with claim 9, wherein at least one of the one or more gestures includes dragging-and-dropping at least one user interface control to be presented in a user interface of the second application.

17. A computer program product comprising one or more hardware storage devices having stored thereon computer-executable instructions that are executable by one or more processors of a computer system to provide a web application that allows users to build applications by interacting with visualizations of code portions, the computer-executable instructions including instructions that are executable to cause the computer system to perform at least the following:
generate a first application, the first application providing a user interface, the user interface including at least:
a canvas comprising a creation area within the user interface in which a user can create a second application; and
one or more controls that allow a user to interact with visualizations of code portions using gestures to thereby create the second application on the canvas.

18. The computer program product in accordance with claim 17, wherein the canvas allows a user to create the second application from scratch, such that no template to create the second application is provided.

19. The computer program product in accordance with claim 17, wherein the user interface also includes one or more templates, wherein the one or more templates may be used as a starting point for creating the second application such that the one or more templates may be manipulated by a user when creating the second application.

20. The computer program product in accordance with claim 17, wherein at least one of the one or more controls allows a user to input declarative code.
